(19) United States
(12) Patent Application Publication
(10) Pub. No.: US 2020/0397129 A1
(43) Pub. Date: Dec. 24, 2020

(54) MULTIPURPOSE SMART DEVICE ACCESSORY HAVING COMPARTMENT

(71) Applicant: Christina Teves, Lawrence, MA (US)

(72) Inventor: Christina Teves, Lawrence, MA (US)

(21) Appl. No.: 16/449,956

(22) Filed: Jun. 24, 2019

(51) Int. Cl. A45F 5/10; A45D 33/26; A45D 42/02; G06F 1/18

(52) U.S. Cl. CPC A45F 5/10; A45D 33/26; A45F 2005/002; G06F 1/183; A45F 2200/0516; A45D 42/02

(57) ABSTRACT

In accordance with aspects and embodiments, a smart device accessory is provided having a base, a body connected to the base at a first end and connected to a top portion at a second end, the top portion having a bottom, side walls extending perpendicularly from the perimeter of the bottom, and a cap positioned perpendicular to the side walls and in parallel to the bottom, wherein the side walls further comprise a first side wall and a second side wall, the second side wall connected to a tray positioned within the compartment formed by the bottom, side walls, and cap of the top portion. The tray may further comprise a tray bottom and tray side wall and be removably received within the compartment formed by the accessory top portion bottom, side walls, and cap, and may receive a cosmetic.

### FIELD OF INVENTION

The present disclosure relates to smart device accessories, and more specifically to multifunctional grip aids having a compartment for a cosmetic or other desirable item.

### BACKGROUND

Smart devices, portable computerized electronics including phones and tablets, have become increasingly pervasive fixtures in modern society. Users are constantly seeking new ways to add additional features to their devices, both technological and mechanical, to increase overall utility and functionality. Protective cases are often used to house these devices and may include, or have affixed to them, grip aids to assist the user in holding the device securely when in use. Alternatively, grip aids may be affixed directly to the device, itself, in the event a case is not desired.

Grip aids and other items affixed or secured to smart devices to increase functionality are often also used to enhance the appearance of a device. Users now not only select the color of their device and the color of any corresponding case, but also often select additional accessories to affix to the device and/or use with the device that further customize the look of the device. This is especially true of younger users, who seek to personalize their smart devices to suit their tastes and personal aesthetic.

Moreover, multifunctional/multipurpose accessories are increasingly desirable. Users of smart devices, and particularly users of add-on accessories to use with smart devices, seek accessories able to perform a plurality of functions. There thus exists a need for multipurpose accessories that facilitate further personalization and customization of smart devices.

### SUMMARY OF THE INVENTION

In accordance with aspects and embodiments, a smart device accessory is provided, the accessory comprising a base having a top side and an under side, the under side having an adhesive, a body connected to the base at a first end and connected to a top portion at a second end, the top portion having a bottom, side walls extending perpendicularly from the perimeter of the bottom, and a cap positioned perpendicular to the side walls and in parallel to the bottom; wherein the side walls further comprise a first side wall and a second side wall, the second side wall connected to a tray positioned within the compartment in the top portion formed by the bottom, side walls, and the cap. In accordance with embodiments, the tray is held in the top portion compartment by a latch having a disengagement button that protrudes from second side wall and is at least partially released from the top portion compartment when the disengagement button is depressed.

In accordance with embodiments, the tray holds at least one cosmetic. The cosmetic may be contained within a tin and received by the tray, or the cosmetic may be received directly by the tray.

In accordance with embodiments, the accessory may further comprise a mirror. The cap of the top portion may have an outer face and an inner face and be hingedly connected to the first side wall. The inner face may be held in contact with a top of the first side wall and a top of the second side wall by a latch, and the inner face of the cap may include a mirror.

In accordance with embodiments, the smart device accessory is adhered to a smart device via the adhesive on the under side of the base. The accessory may be removable and re-attachable to a second smart device by use of the same adhesive.

In accordance with aspects and embodiments, a kit is provided, wherein the kit includes a smart device accessory comprising a base, a body connected to the base at a first end and connected to a top portion at a second end, where the top portion has a bottom, side walls extending perpendicularly from the perimeter of the bottom, and a cap positioned perpendicular to the side walls and in parallel to the bottom, and the side walls further comprise a first side wall and a second side wall, where the second side wall connected to a tray positioned within the compartment formed by the bottom, side walls, and cap of the top portion, and the tray has a tray bottom and tray side wall extending perpendicularly from the perimeter of the tray bottom, where the tray side wall is connected to the second side wall, and wherein the tray is partially releasable from the top portion compartment. The kit includes with the smart device accessory a cosmetic contained within a tin dimensioned to fit within the tray.

In accordance with aspects and embodiments, a smart device accessory is provided, the accessory comprising a base having a top side and an underside, where under side has an adhesive, a body connected to the base at a first end and connected to a top portion at a second end, the top portion having a bottom, side walls extending perpendicularly from the perimeter of the bottom, and a cap positioned perpendicular to the side walls and in parallel to the bottom, and wherein the cap has an outer face and an inner face and is hingedly connected to one of the side walls and held shut by a latch. Disengagement of the latch opens the cap and provides access to the compartment formed by the top bottom and side walls.

In accordance with embodiments the compartment formed by the top bottom and side walls may be dimensioned to hold a key, to hold headphones, or to hold a cosmetic. The inner face of the cap may further include a mirror.

### BRIEF DESCRIPTION OF THE DRAWINGS

FIG. 1 is a side view of a smart device accessory in accordance with aspects and embodiments;

FIG. 2 is a side view of a top portion of a smart device accessory in accordance with aspects and embodiments;

FIG. 3A is a side view of a smart device accessory in accordance with aspects and embodiments;

FIG. 3B is a top view of a smart device accessory in accordance with aspects and embodiments; and

FIGS. 4A-4C show smart device accessories in accordance with aspects and embodiments affixed to represented smart devices.

### DETAILED DESCRIPTION

In accordance with aspects and embodiments, a smart device accessory is provided having more than one functionality. The accessory may be affixed to the smart device or via a protective case affixed to the device to assist the user in holding the device. In accordance with embodiments, the accessory includes a compartment that provides added functionality.

The accessory may have a base having an under side and a top side, the under side having an adhesive adhered thereon. The adhesive may be any suitable material known the art able to secure the accessory to a flat surface and support the weight of smart device. The adhesive may be reusable, such that the accessory can be affixed to a first surface, removed, and affixed to a second surface without any measurable loss in function. In accordance with embodiments, the adhesive may alternatively to, or in addition to, being reusable, be replaceable. Further, the accessory may be adhered or affixed to a surface by non-adhesive means by any other methods known in the art.

The accessory includes a body portion and a top portion, where the body portion extends from the top side of the base and connects to the top portion. The body portion may be rigid or may be flexible such that it can telescope and collapse, varying the distance of the top portion from the base portion. For example, the flexible body portion may allow for the top portion to be in contact or near contact with the top side of the base when in a first position and may enable the top portion to telescope to a distance spaced from the base when in a second position. The flexible body may further allow the top portion to occupy intermediate positions between the first, collapsed position, and the second, fully extended, telescoped position. A user may extend the top portion from the base to the second position or any position spaced from the base to assist in gripping the accessory and device combination. For example, a user may extend the accessory to the second position such that they can fit fingers between the top portion and the base/surface of the device to which the accessory is affixed, to aid in holding the device when in use. The body portion may have a tapered shape and may for example extend from the outer edges of the bottom of the top portion to a surface on the base substantially smaller than the surface area of the base. This taper shape may further facilitate gripping of the device.

In accordance with aspects and embodiments, the top portion may have a bottom, side walls, and a cap such that the top portion forms a compartment capable of containing an item. The top portion may have a shape different or similar to that of the base, and both the base and top portion may for example, be round in shape and of relatively equally surface areas and be substantially smaller than the smart device. The top portion and base may alternatively be square, rectangular, or any other suitable shape, and have be of any size relative to the smart device, with the only limitation being that the base be of equal or lesser size than the surface of the smart device to which it is being affixed. In accordance with embodiments, the accessory will be sized so as not to interfere with other features of the smart device, including for example any buttons used to operate the device and features of the device, such as a built in camera.

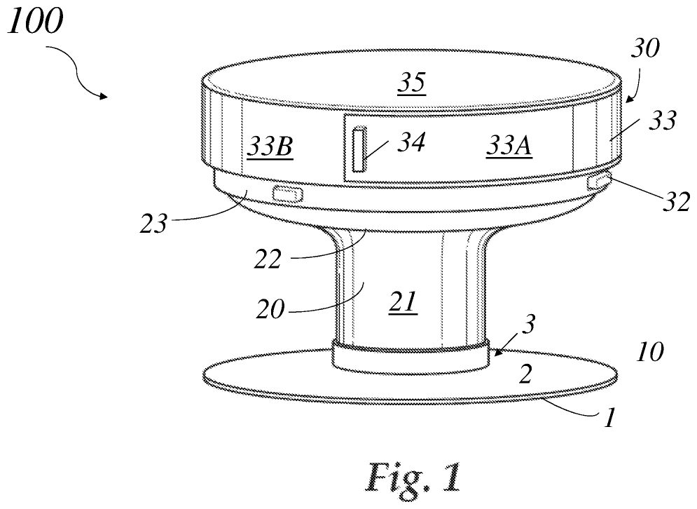

In accordance with embodiments and referring to FIG. 1, an accessory 100 is provided having a base 10, a body 20, and a top portion 30, which may simply be referred to as top 30. Base 10 has under side 1 having thereon a reusable adhesive. Base 10 has top side 2 and flange 3 where base 10 connects to body 20. Body 20 connects base 10 to top 30. Base 10 may be made of any suitable material and may for example be a rigid plastic. Base flange 3 receives body extension 21 at a first end. Body portion 20 further includes body extension 22 and body flange 23. For example, the end of body extension 21 opposite base flange 3 has body extension 22 which as shown, is slightly wider than body extension 21. Body extension 22 connects body extension 21 to body flange 23. Body flange 23 is wider than body extension 22 and connects top 30 to body 20. Body 20, by virtue of having body parts 21, 22, 23, may collapse such that top 30 is in contact with base 10 when in an un-extended position. Conversely, body 20 may be telescoped and extended away from base 10, putting distance between top 30 and base 10. Body 20 may be made of any suitable material and may be made of a flexible material, and may for example, be a rubber material. Though labeled separately, body extensions 21 and 22 and body flange 23 may be a constructed of a single piece of material in a seamless manner. Alternatively, body 20 may be made of rigid materials and may not collapse and extend and may only hold top 30 in one orientation relative to base 10.

Top 30 has protrusions 32 extending from top bottom 31 (not shown) that mate with corresponding apertures on body flange 23 to securely hold top 30. Top 30 has side walls extending perpendicularly from bottom 31 and cap 35 arranged perpendicular to side walls 33 such that a compartment is formed. Top 30 may be made of any material, and is preferably made of a rigid plastic, metal, or combination thereof. Side walls 33 are formed from side walls 33A and 33B. Cap 35 has an inner face and an outer face, and the outer face, i.e., the face visible when cap 35 is held in contact with side walls 33, may have a unique texture, such as facets mimicking a diamond, it may have additional items affixed to it such as crystals and gems, it may have a non-functional design on it, and any other features designed to enhance aesthetics and provide customization to a user. Similarly, base 10 and body 20 may be colored and/or have special material finishes, i.e., glitter, holographic, or shiny finishes, to provide further customization.

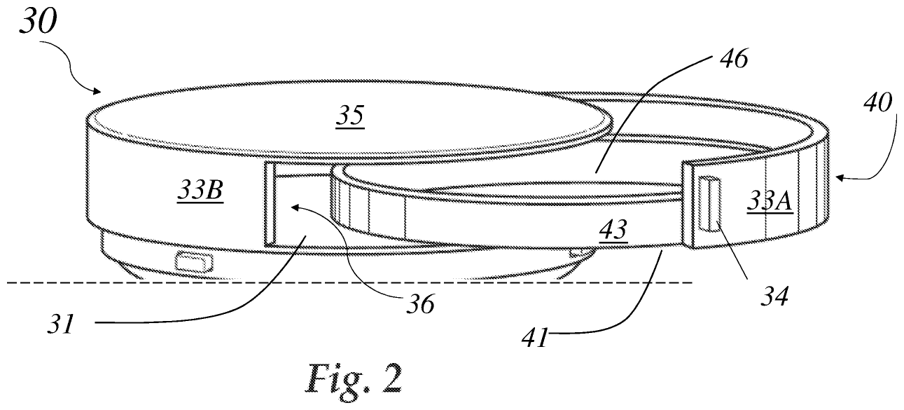

Turning to FIG. 2, in accordance with aspects and embodiments, top 30 has internal tray 40. Internal tray 40 is received in the compartment 36 created by top bottom 31, side walls 33, and cap 35. Tray 40 bottom 41 and side walls extending perpendicularly from bottom 41 to form space 46. Side will 33A functions as a side wall to both top 30 and tray 40. Side wall 33A is dimensioned to have the same height as top side wall 33B. Tray 40 has further has side wall 43, which may be shorter than side wall 33.

Referring to both FIG. 1 and FIG. 2, tray 40 can be completely received within compartment 36. Tray 40 can be removed from top 30 by depressing button 34. Button 34 may be in communication with any known latch system, for example, a mechanical latch or a magnetic latch, that when engaged, holds tray 40 securely in compartment 36 of top 30. When depressed, the latch may be disengaged, allowing tray 40 to be removed from compartment 36. In some embodiments, tray 40 may be entirely removable from top 30. In some embodiments, tray 40 may be fixed within top 30 such that tray 40 and by slid out top 30 but cannot be removed entirely from top 30.

In accordance with aspects and embodiments, a cosmetic may be placed in tray 40. The cosmetic may be a separate unit having its own container, i.e., a tin, including a base and side walls dimensioned to be received in space 46, such that the bottom wall of the cosmetic tin sits on tray bottom 41 and the side walls of the cosmetic tin abut the internal sides of side walls 43 and 33A. Alternatively, the cosmetic may be packed or poured directly into tray 41. Suitable cosmetics for inclusion in top 30 via tray 40 include, but are not limited to, lip gloss, lip stick, blush, bronzer, concealer, eyeshadow, and the like. More than one cosmetic may be included in tray 40. For example, tray 40 may further include a divider that sections space 46. For example, a divider may bisect space 46 and be positioned perpendicular to tray bottom 41 such that on one side of space 46 a lip cosmetic can be provided and on the other side of space 46, a face cosmetic, for example, a blush, can be provided. In embodiments where cosmetics are received by tray 40 as separate standalone tins, several cosmetics may be present in a single tin in accordance with the same principle.

In alternative embodiments, cap 35 of top portion 30 may be hingedly connected to side wall 33A and secured in a closed position by a latch. When the latch is disengaged, cap 35 may be able to swing open, giving access to compartment 36. In some embodiments not having a tray 40, a cosmetic may be provided in compartment 36. In accordance with embodiments, the inner face of cap 35 may include a mirror to aid in the application of any cosmetic contained in compartment 36 or in tray 40.

In accordance with aspects and embodiments, the side walls of top portion 30 may be of convex shape such that a groove runs along side walls 33. This groove may be used to securely hold a hair elastic around top portion 30. This groove may also be used for other purposes, including for example, as a channel in which headphone cables can be wrapped around and secured.

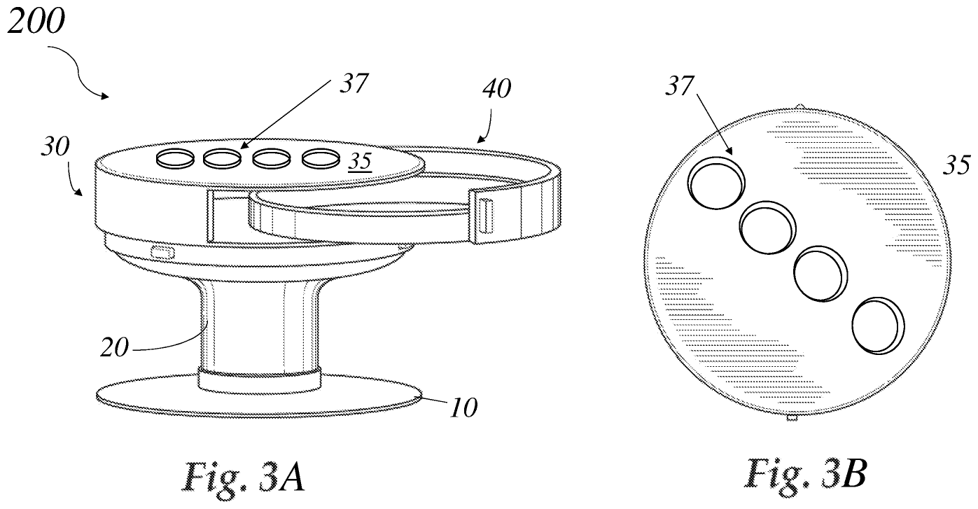

In accordance with aspects and embodiments, tray 40 may instead hold an aromatherapy unit. For example and referring to FIGS. 3A and 3B, an accessory 200 may be provided having a base 10, body 20, top 30, and optional tray 40 as discussed. Cap 35 of top 30 may further include perforations 37 allowing air flow between compartment 36/space 46. A porous material suitable for receiving an essential oil and dispersing the oil's fragrance, for example, lava rock, may be placed in compartment 36 or tray 46. Perforations 37 in cap 35 allow for scent received by the lava rock to be emitted out of compartment 36 and into the atmosphere such that a user can inhale the scent and benefit from any properties associated with the chosen essential oil.

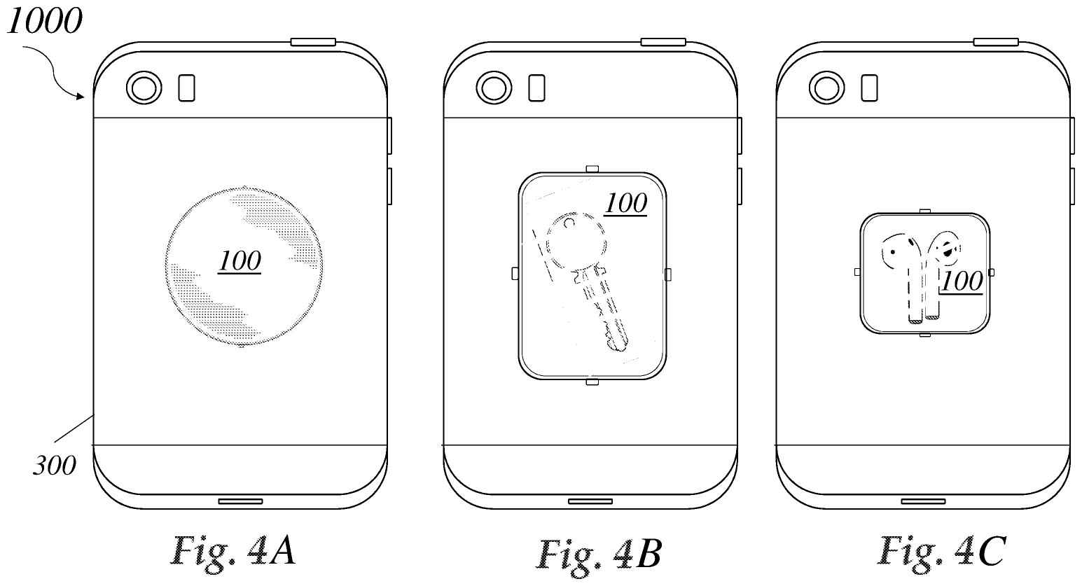

In accordance with aspects and embodiments, the disclosed accessory may be dimensioned to have any suitable shape and may, for example, have a shape able to accommodate a house key, headphones, money, or other small items a user may wish to carry securely. FIGS. 4A-4C show system 1000 having various embodiments of accessory 100 affixed to the back side (non-screen side) of representative smart phone 300.

In accordance with aspects and embodiments, accessory 100 may be permanently fixed to a smart device case. Base 10 may, for example, by bonded to a protective phone case such that the case and accessory are a single saleable item. Accessory 100 may be permanently affixed to such cases by any known means. In embodiments having accessory 100 affixed to a case, base 10 may be a surface of the case or may be a separate base piece joined to a surface of the case.

Although certain representative embodiments and advantages have been described in detail, it will be apparent to those skilled in the art that various modifications and variations can be made in the present invention without departing from the scope or spirit of the invention. Other embodiments of the invention will be apparent to those skilled in the art from consideration of the specification and practice of the invention disclosed herein. It is intended that the specification and examples be considered as exemplary only.

1. A smart device accessory comprising:
a base having a top side and an under side, the under side having an adhesive;
a telescoping body connected to the base at a first end and connected to a top portion at a second end;
the top portion having a bottom, side walls extending perpendicularly from the perimeter of the bottom, and a cap positioned perpendicular to the side walls and in parallel to the bottom; wherein the side walls further comprise a first side wall and a second side wall, the second side wall connected to a tray having a planar surface parallel to the bottom and positioned within a compartment formed by the bottom, side walls, and cap of the top portion.

2. The accessory of claim 1, wherein the tray is held in the top portion compartment by a latch having a disengagement button that protrudes from the second side wall.

3. The accessory of claim 2, wherein the tray is at least partially released from the top portion compartment when the disengagement button is depressed.

4. The accessory of claim 3, wherein the tray is partially released from the top portion compartment when the disengagement button is depressed.

5. The accessory of clam 3, wherein the tray is fully released from the top portion compartment when the disengagement button is depressed.

6. The accessory of claim 3, wherein the tray holds at least one cosmetic.

7. The accessory of claim 6, wherein the at least one cosmetic is contained within a tin and the tin is received by the tray.

8. The accessory of claim 7, wherein the at least one cosmetic is received directly by the tray.

9. The accessory of claim 6, wherein the cap of the top portion has an outer face and an inner face and is hingedly connected to the first side wall and the inner face is held in contact with a top of the first side wall and a top of the second side wall by a latch.

10. The accessory of claim 9, wherein the inner face of the cap includes a mirror.

11. The accessory of claim 10, wherein the under side of the base having the adhesive is affixed to a surface of a smart device.

12. The accessory of claim 11, wherein the accessory is removable and re-attachable to a second smart device.

13. A smart device comprising the accessory of claim 1 attached to a rear surface of the smart device.

14. A kit comprising:
a smart device accessory comprising:
a base;
a telescoping body connected to the base at a first end and connected to a top portion at a second end;
the top portion having a bottom, side walls extending perpendicularly from the perimeter of the bottom, and a cap positioned perpendicular to the side walls and in parallel to the bottom; wherein the side walls further comprise a first side wall and a second side wall, the second side wall connected to a tray positioned within a compartment formed by the bottom, side walls, and cap of the top portion,
the tray having a tray bottom and tray side wall extending perpendicularly from the perimeter of the tray bottom, the tray side wall connected to the second side wall, and wherein the tray is partially releasable from the top portion compartment;
a cosmetic contained within a tin, the tin dimensioned to fit within the tray and,
wherein the cap of the top portion of the accessory includes an outer face and an inner face and is hingedly connected to the first side wall and where the inner face is held in contact with a top of the first side wall and a top of the second side wall by a latch.

15. The kit of claim 14, wherein the inner face of the cap includes a mirror.

16. A smart device accessory comprising:
a base having a top side and an under side, the under side having an adhesive;
a telescoping body connected to the base at a first end and connected to a top portion at a second end;
the top portion having a bottom, side walls extending perpendicularly from the perimeter of the bottom, and a cap positioned perpendicular to the side walls and in parallel to the bottom, wherein the cap has an outer face and an inner face and is hingedly connected to one of the side walls.

17. The accessory of claim 16, wherein disengagement of the latch opens the cap and provides access to the compartment formed by the top, bottom and side walls.

18. The accessory of claim 17, wherein the compartment formed by the top bottom and side walls is dimensioned to hold an item selected from the list comprising a key, a cosmetic, and headphones.

19. The accessory of claim 18, wherein the inner face of the cap includes a mirror.

20. A smart device comprising the accessory of claim 16 attached to a rear surface of the smart device.
